(19) United States
(12) Patent Application Publication
(10) Pub. No.: US 2024/0201379 A1
(43) Pub. Date: Jun. 20, 2024

(54) METHOD AND SYSTEM FOR DETECTING AN OBJECT

(71) Applicants: HYUNDAI MOTOR COMPANY, Seoul (KR); KIA CORPORATION, Seoul (KR)

(72) Inventor: Hyun Ju Kim, Yongin-si (KR)

(73) Assignees: HYUNDAI MOTOR COMPANY, Seoul (KR); KIA CORPORATION, Seoul (KR)

(21) Appl. No.: 18/521,830

(22) Filed: Nov. 28, 2023

(30) Foreign Application Priority Data
Dec. 19, 2022 (KR) 10-2022-0177957

(51) Int. Cl. G01S 17/89

(52) U.S. Cl. CPC G01S 17/89

(57) ABSTRACT

A method for detecting an object includes: generating an exhaust gas meta object having the same data format as a track box for tracking a target object based on an information of a first object box corresponding to an exhaust gas included in a box information indicating a shape of an object; verifying a validity of the information of the first object box based on an association operation between the exhaust gas meta object and pre-stored track boxes; and generating and storing an exhaust gas virtual track based on the information of the first object box when it is determined that the information of the first object box is valid according to the verification.

### CROSS-REFERENCE TO RELATED APPLICATION

The present application claims priority to Korean Patent Application No. 10-2022-0177957, filed on Dec. 19, 2022, the entire contents of which are incorporated herein by reference.

### BACKGROUND OF THE PRESENT DISCLOSURE

### Technical Field

The present disclosure relates to a method and a system for detecting an object.

### Discussion of the Related Art

The LiDAR sensor has a characteristic of generating points for a gas with a high reflectivity such as exhaust gas.

Accordingly, when generating a LiDAR track based on points obtained from the LiDAR sensor, a conventional system for detecting an object may generate a track (also referred to as a track box) representing an exhaust gas discharged from a vehicle.

The exhaust gas discharged from the vehicle may be generated as various types of tracks according to temperature, wind direction, wind speed, and/or a type of exhaust port of the vehicle. In particular, the vehicle may discharge a high concentration of exhaust gas in cold weather. Accordingly, when a target vehicle located close to the vehicle in cold weather discharges the exhaust gas, the exhaust gas may be represented by an output of points by the LiDAR sensor of the vehicle that can be used to generate a track.

The conventional system for detecting an object has a problem of generating a track by forming points representative of exhaust gas discharged by the target vehicle located close to the vehicle as one group alone or by generating a track representing the target vehicle and the exhaust gas as one target object.

Therefore, the system for detecting an object of the vehicle in the related art has a problem of misrecognizing characteristics such as shape, position, and/or speed of the actual target vehicle. In addition, there has been a problem in that the system for detecting an object of the vehicle in the related art recognizes that the shape of the target vehicle being tracked is deformed and misrecognizes the position and/or speed of the target vehicle.

Since the exhaust gas may be erroneously recognized as the target object, or the target vehicle and the exhaust gas are erroneously recognized as one target object, the vehicle may cause a dangerous situation such as sudden braking of the vehicle when the vehicle is being controlled, for example, during autonomous driving control, based on the output result of the system for detecting the object.

### BRIEF SUMMARY

An embodiment of the present disclosure may provide a method and a system for detecting an object capable of solving the problem of misrecognizing an object due to exhaust gas of a vehicle.

For example, the method and the system for detecting an object according to an embodiment of the present disclosure may solve the problem of the related art object detection technology. More specifically, the method and system may solve the problem of erroneously recognizing the exhaust gas of the vehicle, which is frequently generated in winter, as a target object to be considered in the driving control of the vehicle, or of erroneously recognizing the vehicle and the exhaust gas as one target object.

According to an embodiment of the present disclosure, a method for detecting an object around a host vehicle includes generating an exhaust gas meta object having a same data format as a track box for tracking the object, based on information of a first object box corresponding to an exhaust gas included in box information indicating a shape of an object; verifying a validity of the information of the first object box based on an association between the exhaust gas meta object and pre-stored track boxes; and generating and storing an exhaust gas virtual track based on the information of the first object box in response to a determination that the information of the first object box is valid according to the verification.

Verifying the validity of the information of the first object box may include verifying the validity of the information of the first object box based on information of a first track box of the pre-stored track boxes when the exhaust gas meta object is associated with the first track box, and determining that the information of the first object box is valid when the exhaust gas meta object is not associated with the pre-stored track boxes.

Verifying the validity of the information of the first object box based on the information of the first track box may include determining that the information of the first object box is valid or invalid based on at least one of: an age of the first track box; a distance between the first track box and the host vehicle; whether an object of the first track box has moved; classification information of the object of the first track box; speed information of the object of the first track box; a ratio of an overlapped area of the first track box and the first object box; a distance between the first track box and the first object box; and/or a point ratio between the first track box and the first object box.

Generating the exhaust gas virtual track may include: generating a virtual meta object having the same data format as the track box based on the information of the first object box; predicting a first exhaust gas virtual track in a previous time step with respect to the exhaust gas based on the virtual meta object; performing an association between the virtual meta object and the first exhaust gas virtual track; and generating the exhaust gas virtual track by updating the first exhaust gas virtual track when the association between the virtual meta object and the first exhaust gas virtual track succeeds.

Generating the exhaust gas virtual track may include generating the virtual meta object as a second exhaust gas virtual track when the association between the virtual meta object and the first exhaust gas virtual track fails.

Generating the exhaust gas virtual track may include, in response to a number of times that association of the second exhaust gas virtual track fails at later time steps is equal to or greater than a predetermined threshold number, releasing the virtual meta object from the second exhaust gas virtual track.

The method for detecting an object may further include generating a meta object having the same data format as the track box based on a second object box corresponding to an object other than the exhaust gas included in the box information indicating the shape of the object. The method may further include generating a meta object track for tracking an association with the object other than the exhaust gas based on the meta object.

Generating the exhaust gas virtual track may include determining the second exhaust gas virtual track as an exhaust gas virtual memory track in response to the association of the second exhaust gas virtual track succeeding before the number of times that association of the second exhaust gas virtual track fails at later time steps reaches the predetermined threshold number of times, associating the meta object with the exhaust gas virtual memory track, and updating the exhaust gas virtual memory track as the exhaust gas virtual track and removing the meta object when the associating of the meta object with the exhaust gas virtual memory track succeeds.

Generating the exhaust gas virtual track may include performing an association between an output track box of a system for detecting an object and the exhaust gas virtual memory track when the association between the meta object and the exhaust gas virtual memory track fails. Generating the exhaust gas virtual track may also include updating the exhaust gas virtual memory track as the exhaust gas virtual track when the association between the output track box and the exhaust gas virtual memory track succeeds.

The method for detecting an object may further include, when it is determined that the information of the first object box is valid, storing the information of the first object box in a first box information array and storing the information of the second object box in a second box information array. The method may also include, when it is determined that the information of the first object box is not valid, storing information of a third object box included in the box information and corresponding to an object comprising all of the exhaust gas and the object other than the exhaust gas in the second box information array.

The method for detecting an object may further include, when the object is an exhaust gas emission vehicle, determining an arbitrary exhaust gas virtual area in a track box of the object. The method may also include performing an association between the arbitrary exhaust gas virtual area and the pre-stored track boxes. The method may also include, when the arbitrary exhaust gas virtual area and at least one track box among the pre-stored track boxes are associated with each other, generating the at least one track box associated with the arbitrary exhaust gas virtual area as a new exhaust gas virtual track.

According to an aspect of the present disclosure, a system for detecting an object around a host vehicle includes a memory and a processor connected to the memory. The processor is configured to generate an exhaust gas meta object having a same data format as a track box for tracking the object based on an information of a first object box corresponding to an exhaust gas included in a box information indicating a shape of an object. The processor is further configured to verify a validity of the information of the first object box based on an association operation between the exhaust gas meta object and pre-stored track boxes. The processor is further configured to generate and store an exhaust gas virtual track based on the information of the first object box in response to a determination that the information of the first object box is valid according to the verification.

The processor may be further configured to verify the validity of the information of the first object box based on the information of a first track box of the pre-stored track boxes when the exhaust gas meta object is associated with the first track. The processor may be configured to determine that the information of the first object box is valid when the exhaust gas meta object is not associated with the pre-stored track boxes.

The processor may be further configured to determine that the information of the first object box is valid or invalid based on at least one of: an age of the first track box; a distance between the first track box and the host vehicle; whether an object of the first track box has moved; classification information of the object of the first track box; speed information of the object of the first track box; a ratio of an overlapped area of the first track box and the first object box; a distance between the first track box and the first object box; and/or a point ratio between the first track box and the first object box.

The processor may be further configured to: generate a virtual meta object having the same data format as the track box based on the information of the first object box; predict a first exhaust gas virtual track in a previous time step with respect to the exhaust gas based on the virtual meta object; perform an association between the virtual meta object and the first exhaust gas virtual track; and generate the exhaust gas virtual track by updating the first exhaust gas virtual track when the association between the virtual meta object and the first exhaust gas virtual track succeeds.

The processor may be further configured to generate the virtual meta object as a second exhaust gas virtual track when the association between the virtual meta object and the first exhaust gas virtual track is failed.

The processor may be further configured to, in response to a number of times in which association of the second exhaust gas virtual track fails at later time steps is equal to or greater than a predetermined threshold number, release the virtual meta object from being generated as the second exhaust gas virtual track.

The processor may be further configured to generate a meta object having the same data format as the track box based on a second object box corresponding to an object other than the exhaust gas included in the box information indicating the shape of the object. The processor may be further configured to generate a meta object track for tracking association with the object other than the exhaust gas based on the meta object.

The processor may be further configured to determine the second exhaust gas virtual track as an exhaust gas virtual memory track when the association of the second exhaust gas virtual track succeeds before the number of times in which association of the second exhaust gas virtual track fails at later time steps reaches the predetermined threshold number of times, associate the meta object with the exhaust gas virtual memory track, and update the exhaust gas virtual memory track as the exhaust gas virtual track and remove the meta object when the association of the meta object with the exhaust gas virtual memory track succeeds.

The processor may be configured to perform an association between an output track box of a system for detecting an object and the exhaust gas virtual memory track when the association between the meta object and the exhaust gas virtual memory track fails. The processor may further be configured to update the exhaust gas virtual memory track as the exhaust gas virtual track when the association between the output track box and the virtual memory track succeeds.

An embodiment of the present disclosure may provide a method and a system for detecting an object capable of managing a track box generated by a conventional exhaust gas with a false track.

Therefore, the method and the system for detecting an object may output only a track box of an actual target object by excluding a false track corresponding to the exhaust gas from the output. Control of the vehicle by recognizing the exhaust gas as an object is thereby prevented when controlling the driving of the vehicle.

### BRIEF DESCRIPTION OF DRAWINGS

FIG. 1 is a block diagram of a vehicle according to an embodiment of the present disclosure.

FIG. 2 is a diagram illustrating a feature of the processor according to the embodiment of FIG. 1.

FIGS. 3A and 3B show a diagram and an information array for describing box information indicating a shape of an object, according to an embodiment of the present disclosure.

FIG. 4 is a flowchart showing an operation of a system for detecting an object according to an embodiment of the present disclosure.

FIG. 5 is a flowchart showing an operation for generating a meta object input box information array and/or an exhaust gas input box information array of a system for detecting an object according to the embodiment of FIG. 4.

FIG. 6 is a flowchart showing a validity verification operation of the system for detecting an object according to the embodiment of FIG. 4.

FIG. 7 is a diagram illustrating a track box and a first object box according to an embodiment of the present disclosure.

FIGS. 8A and 8B are flowcharts showing a management-operation of a false track of a system for detecting an object according to the embodiment of FIG. 4.

FIG. 9 is a flowchart showing an operation of a system for detecting an object according to an embodiment of the present disclosure.

FIG. 10 is a diagram for describing an operation of associating an exhaust gas virtual region with a track box according to an embodiment of the present disclosure.

FIG. 11 is a flowchart showing an operation of a system for detecting an object according to an embodiment of the present disclosure.

FIGS. 12A-15D are diagrams for explaining an effect of determining an exhaust gas as a false track in a state in which a preceding vehicle discharges the exhaust gas according to an embodiment of the present disclosure.

### DETAILED DESCRIPTION

The present specification does not describe all elements of the embodiments. General content in the technical field to which the present disclosure pertains or overlapping content between the disclosed embodiments has been omitted. The terms “unit”, “module”, or “device” used in the specification may be implemented by software or hardware. According to various embodiments, a plurality of “units”, “modules”, or “devices” may be implemented as one element, or one “unit”, “module”, or “device” may include the plurality of elements.

Throughout the specification, where a part is “associated” to another part, this includes not only a case of being directly associated but also a case of being indirectly associated. The indirect connection includes being associated through a wireless communication network.

In addition, when a part “includes” an element, this means that other elements may be further included, rather than excluding other elements, unless specifically stated otherwise.

Terms including ordinals such as “first”, “second”, and the like. may be used to describe various elements, but the elements are not limited by the terms. The terms are used only for the purpose of distinguishing one component from another component.

A singular expression includes a plural expression unless the context clearly indicates otherwise.

In each step, the identification symbol is used for convenience of description. The identification symbol does not describe the order of each step, and each step may be performed differently from the stated order unless a specific order is clearly described in the context.

An embodiment of the present disclosure may provide a technology of analyzing the characteristics of an exhaust gas to determine and remove the exhaust gas that is being discharged from a target vehicle based on a shape. An embodiment may also provide a technology of managing a LiDAR track representing the exhaust gas as a separate track (also referred to as a false track) that should not be used for driving control of the vehicle.

Hereinafter, operation principles and embodiments of the present disclosure are described below with reference to the accompanying drawings.

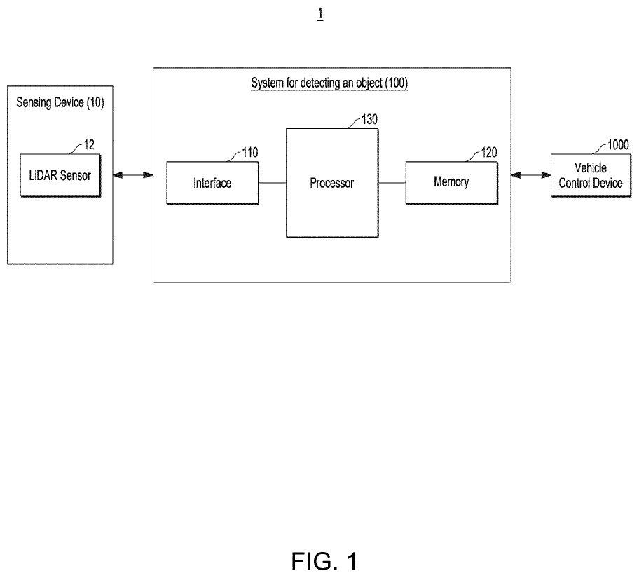

FIG. 1 is a block diagram of a vehicle according to an embodiment of the present disclosure.

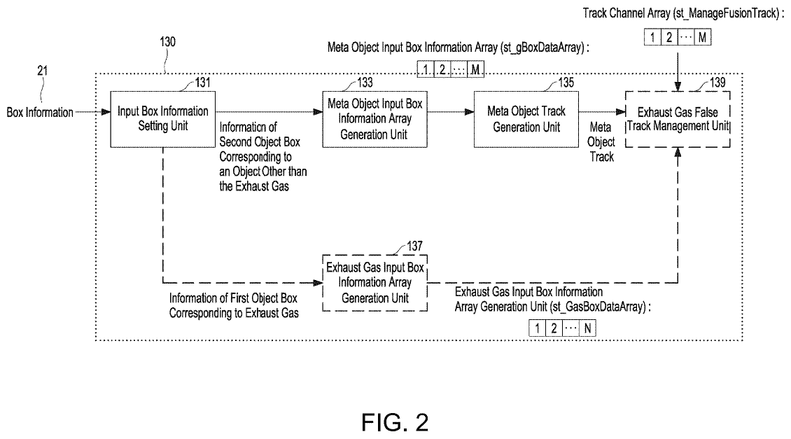

FIG. 2 is a diagram illustrating a feature of the processor according to the embodiment of FIG. 1.

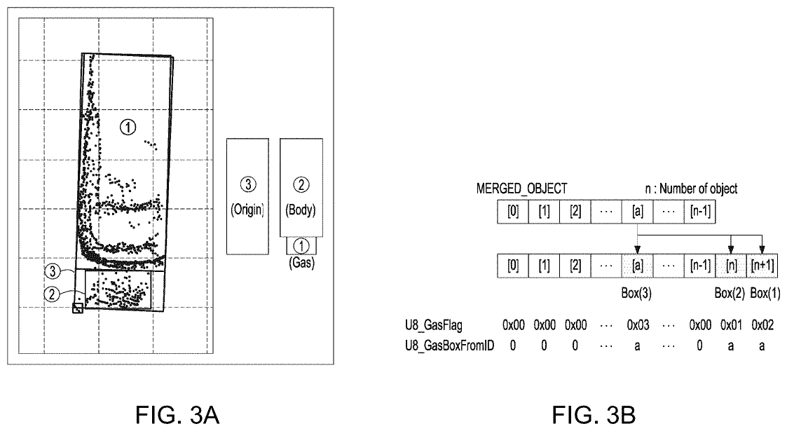

FIGS. 3A and 3B are diagrams for describing box information indicating, i.e., indicative of, representing, a shape of an object, according to an embodiment of the present disclosure.

Referring to FIG. 1, the vehicle 1 may include a sensing device 10, a system 100 for detecting an object, and/or a vehicle control device 1000.

The sensing device 10 may include one or more devices capable of acquiring information about an object (also referred to as a target) that is located around, i.e., surrounding, nearby, in the vicinity of, or the like, the vehicle 1.

The sensing device 10 may include a LIDAR sensor 12.

The LiDAR sensor 12 may include one or more LiDAR sensors. The LiDAR sensor may be mounted in or on the vehicle 1 and generate LiDAR data which includes a plurality of point data (also referred to as point cloud data) by emitting a laser pulse toward the periphery of the vehicle 1.

Although not shown, the sensing device 10 may further include a radar (not shown) capable of sensing objects around the vehicle 1 and/or a camera (not shown) capable of obtaining image data around the vehicle 1.

The system 100 for detecting an object may include an interface 110, a memory 120, and/or a processor 130.

The interface 110 may transmit a command or data input from another device (e.g., the sensing device 10 and/or the vehicle control device 1000) of the vehicle 1 or a user to another feature element of the system 100 for detecting an object. Alternatively, the interface 110 may output a command or data received from another feature element of the system 100 for detecting an object to another device of the vehicle 1.

The interface 110 may include a communication module (not shown) to communicate with other devices of the vehicle 1.

For example, the communication module may include a communication module capable of performing communication between devices of the vehicle 1, for example, controller area network (CAN) communication and/or local interconnect network (LIN) communication, through a vehicle communication network. Further, the communication module may include a wired communication module (e.g., a power line communication module) and/or a wireless communication module (e.g., a cellular communication module, a Wi-Fi communication module, a short-range wireless communication module, and/or a global navigation satellite system (GNSS) communication module).

The memory 120 may store various data used by at least one feature element of the system 100 for detecting an object, for example, input data and/or output data for a software program and a command related thereto.

The memory 120 may include a nonvolatile memory such as a cache, a Read Only Memory (ROM), a Programmable ROM (PROM), an Erasable Programmable ROM (EPROM), an Electrically Erasable Programmable ROM (EEPROM), and/or a flash memory, and/or a volatile memory such as a Random Access Memory (RAM).

The processor 130 (also referred to as a control circuit or controller) may be configured to control at least one other element (e.g., a hardware element (e.g., an interface and/or memory 120 and/or software element (software program)) of the system 100 for detecting an object, and various data processing and operations may be performed by the processor 130.

The processor 130 may generate a track box for tracking the object based on the points obtained from the LiDAR sensor 12. Throughout the present disclosure, a track or a track box may refer to a bounding box, i.e., a virtual bounding box, for tracking an object, an exhaust gas, or both the object and the exhaust gas.

The processor 130 may generate an exhaust gas virtual track corresponding to a false track indicating, i.e., indicative of, representing, the exhaust gas discharged by the object. The processor 130 may store the generated exhaust gas virtual track in the memory 120 to manage the exhaust gas virtual track.

The processor 130 may allow the vehicle control device 1000 to control the driving of the vehicle 1 through the output of the track box excluding the exhaust gas virtual track.

Referring to FIG. 2, the processor 130 may include an input box information setting unit 131, a meta object input box information array generation unit 133, a meta object track generation unit 135, an exhaust gas input box information array generation unit 137, and/or an exhaust gas false track management unit 139.

The input box information setting unit 131 may set the input box information based on the box information 21 indicating the shape of the previously obtained object. In other words, the box information 21 may include data indicative of the shape of the object.

The box information 21 indicating the shape of the object may include information of a first object box corresponding to the exhaust gas, information of a second object box corresponding to an object (also referred to as an object other than the exhaust gas) such as a target vehicle which is to be considered when controlling the host vehicle, and/or information of a third object box including both the exhaust gas and the object other than the exhaust gas.

For example, the box information 21 indicating the shape of the object may be generated based on points acquired through the LiDAR sensor 12.

FIGS. 3A and 3B are diagrams for describing box information indicating a shape of an object, according to an embodiment.

Referring to FIG. 3A, the box information indicating the shape of the object may include information of a first object box \textcircled{1} (Gas) corresponding to the exhaust gas of the target vehicle, information of a second object box \textcircled{2} (Body) corresponding to the target vehicle, and information of a third object box \textcircled{3} (Origin) generated based on points corresponding to the target vehicle and points corresponding to the exhaust gas.

For example, referring to FIG. 3B, the system 100 for detecting an object may obtain a box information indicating a shape of an object in the form of a MERGED_OBJECT structure as shown in an information array as shown in FIG. 3B.

Referring to FIG. 3B, the box information indicating the shape of the object may be provided in multiple pieces. The multiple pieces of the box information may be sequentially stored from the front of the array.

For example, when the box information of the array [a] is obtained for the data as shown in FIG. 3A, the information of the third object box \textcircled{3} (Origin) may be stored in the array [a], the information of the second object box \textcircled{2} (Body) may be stored in the array [n] immediately after the array [n−1] in which the box information of the last object is stored, and the information of the first object box \textcircled{1} (Gas) may be stored in the array [n+1].

For example, according to the following operation of the processor 130 in advance, box information indicating the shape of the object as shown in FIG. 3B may be generated and provided to the input box information setting unit 131.

The processor 130 may generate the first object box \textcircled{1} (Gas), the second object box \textcircled{2} (Body), and the third object box \textcircled{3} (Origin) when it is detected that the objects before the array [a] do not include the exhaust gas and the object of the array [a] includes the exhaust gas.

In addition, the processor 130 may increase the number of objects by 2 and append information of the second object box \textcircled{2} (Body) and the first object box \textcircled{1} (Gas) to the end of the array ([n−1] end). In other words, the processor 130 may store the information of the second object box \textcircled{2} (Body) in the array [n] and store the information of the first object box \textcircled{1} (Gas) in the array [n+1].

In addition, the processor 130 may store (or write) the information of the third object box \textcircled{3} in the array [a].

The input box information setting unit 131 may identify whether the box information 21 includes information of the first object box corresponding to the exhaust gas and/or information of the second object box corresponding to an object other than the exhaust gas.

In addition, when the box information 21 includes the information of the first object box corresponding to the exhaust gas, the input box information setting unit 131 may transmit the information of the first object box corresponding to the exhaust gas to the input box information array generation unit 137.

When the box information 21 includes information of a second object box corresponding to an object other than the exhaust gas, the input box information setting unit 131 may transmit the information of the second object box to the meta object input box information array generation unit 133.

The meta object input box information array generation unit 133 may generate the meta object input box information array (st_gBoxDataArray) (also referred to as a second box information array) as illustrated in FIG. 2. Also, the meta object input box information array generation unit 133 may store the information of the second object box in any one array space of the meta object input box information array (st_gBoxDataArray) illustrated in FIG. 2. The maximum number M of arrays of the meta object input box information array (st_gBoxDataArray) may be a predetermined number (e.g., M=7).

The meta object track generation unit 135 may receive the meta object input box information array (st_gBoxDataArray) from the meta object input box information array generation unit 133. The meta object track generator 135 may generate a meta object based on the information of a second object box stored in the meta object input box information array (st_gBoxDataArray) and generate a meta object track based on the meta object.

The meta object in the embodiment of the present disclosure refers to an object generated configured to have the same data format as the track channel based on the input information of the second object box. Also, the meta object track refers to a track box (or track channel) made of the meta object for tracking an association based on a measurement value in a current time step.

The exhaust gas input box information array generation unit 137 may generate the exhaust gas input box information array (st_gGasBoxDataArray) (also referred to as a first box information array) shown in FIG. 2. Further, the exhaust gas input box information array generation unit 137 may store the information of the first object box in any one array space of the exhaust gas input box information array (st_gGasBoxDataArray) illustrated in FIG. 2. The maximum number N of the exhaust gas input box information array (st_gGasBoxDataArray) may be a predetermined number (e.g., N=5).

The exhaust gas false track management unit 139 may perform an exhaust gas false track management operation based on the meta object track generated by the meta object track generation unit 135, the exhaust gas input box information array (st_gGasBoxDataArray) generated by the exhaust gas input box information array generation unit 137, and/or a previously generated and stored track box array (st_manageFusionTrack) (also referred to as a track channel array). The maximum number M of the track box array (st_manageFusionTrack) may be a predetermined number (e.g., M=7).

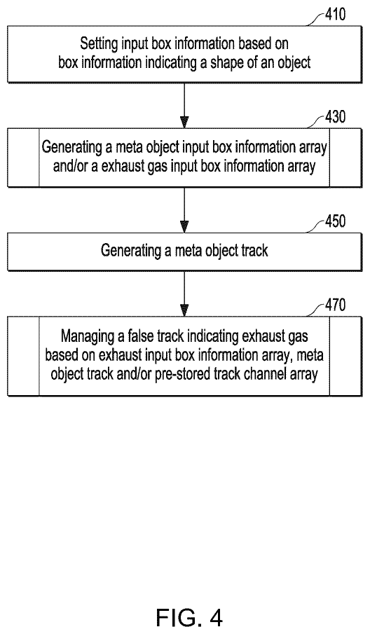

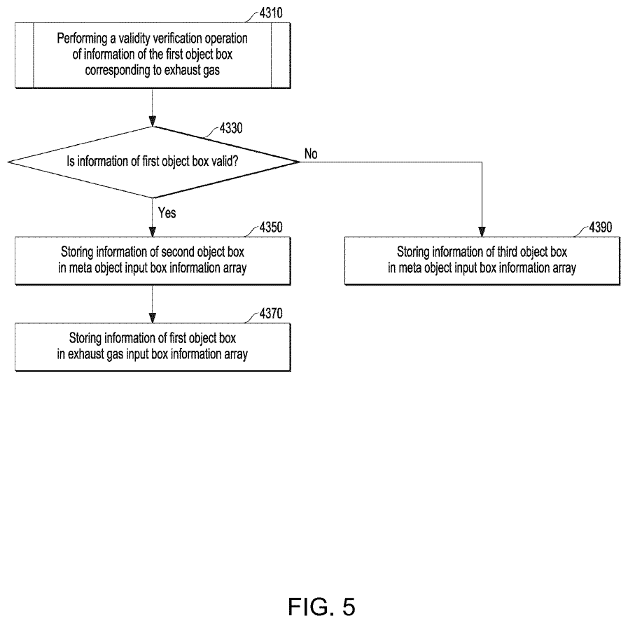

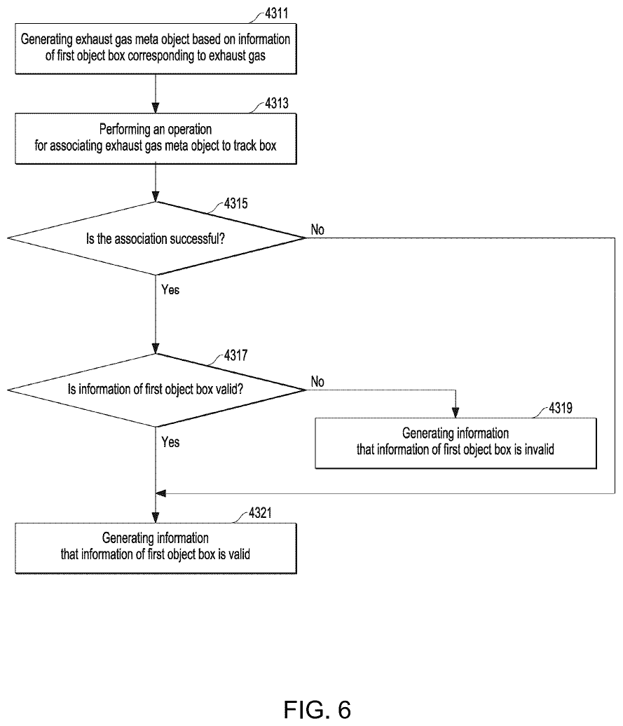

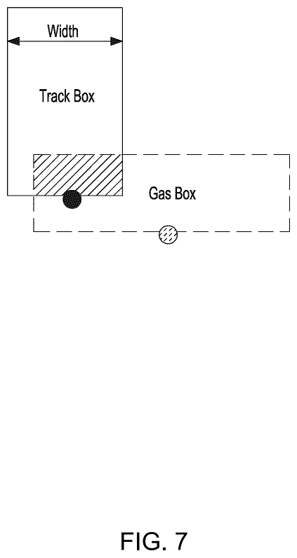

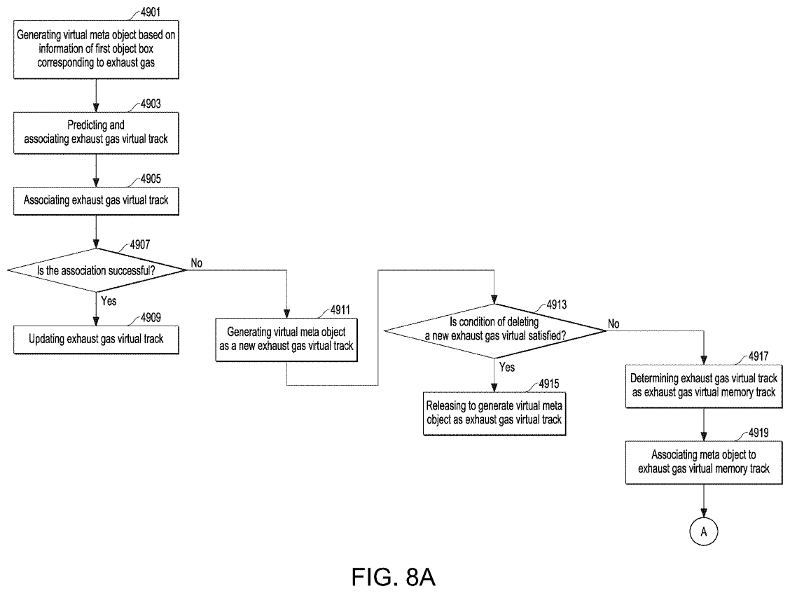

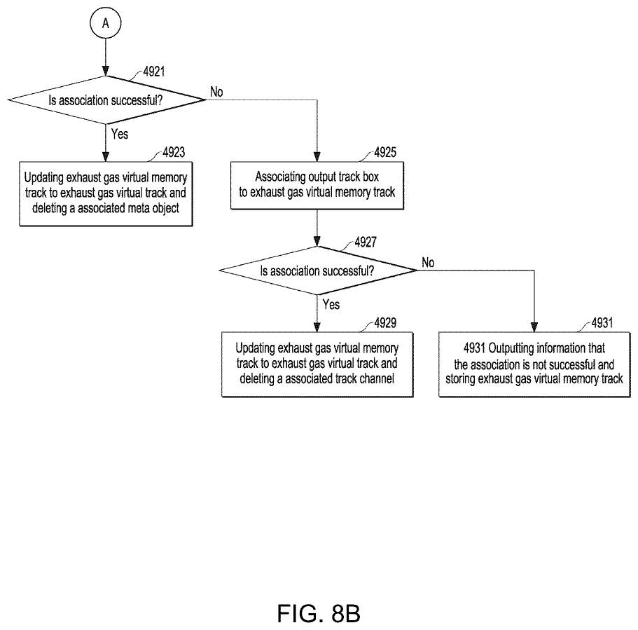

FIG. 4 is a flowchart showing an operation of the system 100 for detecting an object (and/or the processor 130) according to one embodiment of the present disclosure. FIG. 5 is a flowchart showing an operation for generating a meta object input box information array and/or an exhaust gas input box information array of the system 100 for detecting an object (and/or the processor 130) according to the embodiment of FIG. 4. FIG. 6 is a flowchart showing a validity verification operation of the system 100 for detecting an object (and/or the processor 130) according to the embodiment of FIG. 4. FIG. 7 is a diagram illustrating a track box and a first object box according to an embodiment of the present disclosure. FIG. 8A and FIG. 8B are flowcharts showing a management operation of a false track of the system 100 for detecting an object (and/or the processor 130) according to the embodiment of FIG. 4.

Referring to FIG. 4, the system 100 for detecting an object may set input box information based on box information indicating a shape of an object in operation 410.

The system 100 for detecting an object may set the information of the first object box as the input box information when the box information indicating the shape of the object includes only the information of the first object box corresponding to the exhaust gas.

When the box information indicating the shape of the object includes the information of a first object box corresponding to the exhaust gas and the information of the second object box corresponding to an object other than the exhaust gas, the system 100 for detecting an object may set each of the information of the first object box and the information of the second object box as the input box information.

The system 100 for detecting an object may generate a meta object input box information array and/or an exhaust gas input box information array according to the setting of the input box information (430).

The system 100 for detecting an object may generate the exhaust gas input box information array based on the information of the first object box. Also, the system 100 for detecting an object may generate the meta object input box information array based on the information of the second object box.

For example, the system 100 for detecting an object may generate the meta object input box information array and/or the exhaust gas input box information array through operations such as those of FIG. 5.

Referring to FIG. 5, the system 100 for detecting an object may perform a validity verification operation of the information of the first object box corresponding to the exhaust gas (4310).

For example, the system 100 for detecting an object may perform a validity verification operation of the information of the first object box corresponding to the exhaust gas through operations as illustrated in FIG. 5.

Referring to FIG. 6, the system 100 for detecting an object may generate an exhaust gas meta object based on the information of the first object box corresponding to the exhaust gas (4311).

The exhaust gas meta-object refers to an object generated to have the same data format as that of a track box (also referred to as a track channel) based on the information of the first object box corresponding to the exhaust gas.

The system 100 for detecting an object may perform an operation for associating the exhaust gas meta object and the track box (4313).

The system 100 for detecting an object may perform an operation for association between the exhaust gas meta object generated in a current time step and at least one of the track boxes generated in a previous time step by applying an association technology between the object box and the track box in the related art.

The system 100 for detecting an object may determine whether the association between the exhaust gas meta object and the track box is successful (4315).

When the association of the system 100 for detecting an object is successful, the operation 4317 may be performed. Otherwise, the operation 4321 may be performed.

The system 100 for detecting an object may determine whether the information of the first object box is valid based on information of the associated track box (4317).

The system 100 for detecting an object may determine that the information of the exhaust gas box is valid when a predetermined condition is satisfied. The system 100 may determine that the information of the exhaust gas box is invalid when the predetermined condition is not satisfied.

For example, the predetermined condition may include at least one of the following conditions, and when even one of the following conditions is not satisfied, the system 100 for detecting an object may determine that the information of the first object box is invalid.

### <Conditions>

1. In a case in which the associated track box is in an unstable state (e.g., if the age of the associated track box is less than or equal to the threshold age (5), it may be determined that the associated track box is in an unstable state),
2. In a case in which the associated track box exceeds the longitudinal distance condition (e.g., when the longitudinal distance between the associated track box and the vehicle 1 is greater than a predetermined longitudinal distance (e.g., 20 m), it may be determined that the associated track box is out of the longitudinal distance condition).
3. In a case in which the associated track box is a track box of a moving object, the moving object is classified as an unknown vehicle, and a speed of the moving object does not satisfy a predetermined average speed condition (e.g., if the average speed of the moving object of the associated track box is greater than a predetermined average speed degree (e.g., 40 kph), it may be determined that the average speed condition is not satisfied), and
4. In a case in which at least one of the following is not satisfied when the object of the associated track box is classified as a commercial vehicle, not a vehicle emitting exhaust gas (simply referred to as ‘an exhaust gas vehicle’)(e.g., it is determined that the object of the associated track box is an exhaust gas vehicle when the box information indicating a shape of the object of the associated track box includes information of an object box corresponding to the exhaust gas. In addition, it is determined that the object of the associated track box is determined to be a commercial vehicle when the object of the associated track box is determined to be a commercial vehicle in the classification process or the size of the object of the associated track box is greater than a predetermined size.)
   4-1. Satisfying a predetermined overlap ratio,
   4-2. Satisfying a predetermined distance condition, and
   4-3. Satisfying a predetermined points ratio.

For example, as shown in FIG. 7, assuming that a track box and a first object box partially overlap each other, the system 100 for detecting an object may identify whether the condition of 4-1 is satisfied through Equation 1 below.

For example, the system 100 for detecting an object may calculate an overlap ratio, i.e., a ratio of an overlapped area between the track box and the first object box (gas box) via Equation 1 shown below.

$${ε}_{overlap ratio} = \frac{{Area}_{gas\_box}}{{Area}_{track\_box}} \times 100 \qquad Equation 1$$

In Equation 1 shown above, ε_{overlap ratio} is a ratio of an overlapped area between the track box and the first object box, Area_{gas_box} is an area of the first object box, and Area_{track_box} is an area of the track box.

In addition, when the ratio of the overlapped area between the track box and the first object box (gas box) is smaller than a predetermined threshold overlapped area ratio (e.g., 30), the system 100 for detecting an object may determine that the ratio of the overlapped area 4-1 satisfies the predetermined overlapped area ratio.

In addition, as shown in FIG. 7, assuming that the track box and the first object box partially overlap each other, the system 100 for detecting an object may identify whether the condition of 4-2 is satisfied through Equation 2 shown below.

For example, the system 100 for detecting an object may calculate a distance between the track box and the first object box (gas box) via Equation 2 shown below.

$$distance = \sqrt{( {( {x}_{1}^{Trk} - {x}_{2}^{Gas} )}^{2} + {( {y}_{1}^{Trk} - {y}_{2}^{Gas} )}^{2} )} \qquad Equation 2$$

In Equation 2 shown above, distance is a distance between the track box (Track Box) and the first object box (Gas Box), x₁^{Trk} is an X coordinate value of the track box (Track Box), y₁^{Trk}: a Y coordinate value of the track box (Track Box), x₂^{Gas} is a X coordinate value of the first object box (Gas Box), and y₂^{Gas} is a Y coordinate value of the first object box (Gas Box))

In addition, when the distance between the track box (Track Box) and the first object box (Gas Box) is smaller than a value (for example, Width/2) determined based on the width of the track box (Track Box), the above predetermined distance condition of 4-2 is determined to be satisfied.

In addition, as shown in FIG. 7, assuming that a track box (Track Box) and a first object box (Gas Box) partially overlap each other, the system 100 for detecting an object may identify whether the condition of 4-3 is satisfied via Equation 3 shown below.

For example, the system 100 for detecting an object may calculate a point ratio between the track box (Track Box) and the first object box (Gas Box) via Equation 3 shown below.

$${ε}_{points ratio} = \frac{Num of {Points}_{gas\_box}}{Num of {Points}_{track\_box}} \times 100 \qquad Equation 3$$

In Equation 3, ε_{points ratio} is the point ratio, Num of Points_{gas_box}, is the number of points of the first object box, and Num of Points_{track box} is the number of points of the track box.

Further, when the point ratio between the track box (Track Box) and the first object box (Gas Box) is greater than a predetermined threshold point ratio (e.g., 70), the system 100 for detecting an object may determine that the predetermined point ratio condition of 4-3 is satisfied.

The system 100 for detecting an object may perform operation 4321 when the information of the first object box is valid. The system 100 may perform operation 4319 when the information of the first object box is not valid.

The system 100 for detecting an object may generate information that the information of the first object box is not valid (4319).

The system 100 for detecting an object may generate information that the information of the first object box is valid (4321).

Referring to FIG. 5, the system 100 for detecting an object may determine whether the information of the first object box is valid information according to the performance of the validity verification operation of the box information including the exhaust gas (4330).

The system 100 for detecting an object may perform operation 4350 and/or operation 4370 when the information of the first object box is valid information. The system 100 may perform operation 4390 when the information is not valid information.

The system 100 for detecting an object may store the information of the second object box in any one array space of the meta object input box information array (st_gBoxDataArray) as shown in FIG. 2 (4350).

The system 100 for detecting an object may store the information of the first object box in any one array space of the exhaust gas input box information array (st_gGasBoxDataArray) as shown in FIG. 2 (4370).

The system 100 for detecting an object may store the information of the third object box in any one array space of the meta object input box information array (st_gBoxDataArray) as shown in FIG. 5 (4390).

Referring to FIG. 4, the system 100 for detecting an object may generate a meta object track based on the information stored in the meta object input box information array (450).

For example, a meta-object track refers to a track box (also referred to as a track channel) made of a meta-object for tracking association (based on a measurement value at a current time).

The system 100 for detecting an object may perform a management operation of a false track indicating the exhaust gas based on the exhaust gas input box information array, the meta object track, and/or a pre-stored track box array, i.e., a previously stored track box array (also referred to as a track channel array) (470).

For example, the system 100 for detecting an object may perform a management operation of the false track indicating an exhaust gas through operations such as those of FIGS. 8A and 8B.

The system 100 for detecting an object may generate a virtual meta object based on the information of the first object box information corresponding to the exhaust gas stored in the exhaust gas input box information array (4901).

The virtual meta-object refers to an object that is generated to have the same data format as that of the track box (also referred to as a track channel) based on the information of the first object box corresponding to the exhaust gas and is not actually output but is managed inside.

The system 100 for detecting an object may predict an exhaust gas virtual track based on the virtual meta object (4903).

For example, the system 100 for detecting an object may predict the position of the exhaust gas virtual track at a previous time step by predicting the exhaust gas virtual track generated at the previous time step at a current time step by applying a conventional prediction technique.

The system 100 for detecting an object may associate the exhaust gas virtual track (4905).

For example, the system 100 for detecting an object may perform an operation for associating the exhaust gas virtual track at the position predicted in the previous time step with the exhaust gas virtual track of the virtual meta object by applying a related art association technique.

The system 100 for detecting an object may determine whether the association of the exhaust gas virtual track is successful (4907).

The system 100 for detecting an object may perform operation 4909 when the association is successful, and otherwise perform operation 4911.

The system 100 for detecting an object may update the exhaust gas virtual track (4909).

The system 100 for detecting an object may generate the virtual meta object as a new exhaust gas virtual track (4911).

The system 100 for detecting an object may determine whether a predetermined deletion condition of the exhaust gas virtual track generated in operation 4911 is satisfied (4913).

The predetermined deletion condition may include a case in which the exhaust gas virtual track generated in operation 4911 is not associated when the association is performed at every change in the time step. In other words, the number of times that the association fails (or the number of times that the association is maintained without being updated) is a predetermined threshold number.

Accordingly, the system 100 for detecting an object may determine whether the number of times that are not associated and updated for each change in the time step after the generation of the exhaust gas virtual track in the specific time step is equal to or greater than the predetermined threshold number.

The system 100 for detecting an object may perform operation 4915 when the predetermined deletion condition of the new exhaust gas virtual track is satisfied. The system 100 may perform operation 4917 when the predetermined deletion condition is not satisfied.

The system 100 for detecting an object may release the generation of the virtual meta object as the exhaust gas virtual track. In other words, the system 100 may delete the related information of the exhaust gas virtual track generated in operation 4911 (4915).

The system 100 for detecting an object may determine the exhaust gas virtual track generated in operation 4911 as the exhaust gas virtual memory track (4917).

The system 100 for detecting an object may perform the association between the meta object and the exhaust gas virtual memory track (4919).

The system 100 for detecting an object may perform an association between the meta object and the exhaust gas virtual memory track by applying a conventional association technique.

The meta-object refers to an object generated to have the same data format as the track channel based on the information of the second object box.

Referring to FIG. 8B, the system 100 for detecting an object may determine whether the meta object and the exhaust gas virtual memory track are successfully associated (4921).

The system 100 for detecting an object may perform operation 4923 when the meta object and the exhaust gas virtual memory track are successfully associated. The system 100 may perform operation 4925 when the meta object and the exhaust gas virtual memory track are not successfully associated.

The system 100 for detecting an object may update the exhaust gas virtual memory track to the exhaust gas virtual track and remove the meta object associated with the exhaust gas virtual memory track according to operation 4919 (4923).

The system 100 for detecting an object may perform the association between an output track box (also referred to as an output track channel) and the exhaust gas virtual memory track (4925).

The system 100 for detecting an object may perform the association between the output track box and the exhaust gas virtual memory track by applying the conventional association technology.

The output track box may refer to a track box that is maintained in the existing state and is output for the control of the vehicle 1 by the vehicle control device 1000.

The system 100 for detecting an object may determine whether the association between the output track box and the exhaust gas virtual memory track is successful (4927).

The system 100 for detecting an object may perform operation 4929 when the association between the output track box and the exhaust gas virtual memory track is successful. The system 100 may perform operation 4931 when the association between the output track box and the exhaust gas virtual memory track is not successful.

The system 100 for detecting an object may update the exhaust gas virtual memory track to the exhaust gas virtual memory track and remove the output track box associated with the exhaust gas virtual memory track according to operation 4925 (4929).

The system 100 for detecting an object may store the output of the association failure information and/or the exhaust gas virtual memory track (4931).

According to the above-described operations, information on whether the object is an exhaust gas emission vehicle and/or information on the track box of the object may be stored.

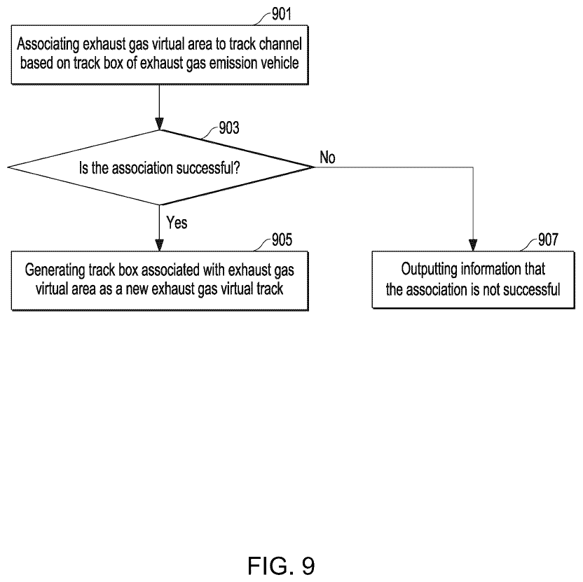

Accordingly, when it is determined that the object is an exhaust gas discharge vehicle and the information of the track box of the corresponding object is stored, the system 100 for detecting an object may additionally determine whether there is a newly overlapped track box inside the stored track box as shown in FIG. 9.

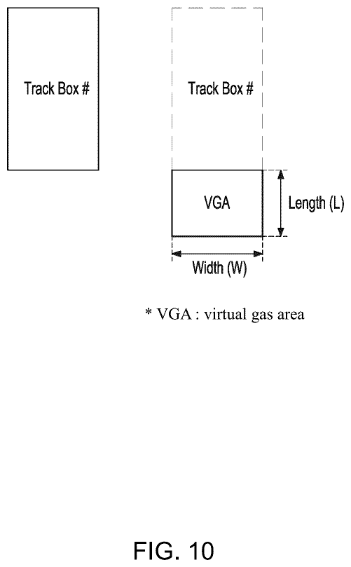

FIG. 9 is a flowchart showing an operation of the system 100 for detecting an object (and/or the processor 130) according to an embodiment of the present disclosure. FIG. 10 is a diagram for describing an operation of associating an exhaust gas virtual area with a track box according to an embodiment of the present disclosure.

Referring to FIG. 9, the system 100 for detecting an object may perform an association between a track box and an exhaust gas virtual area based on a track box (also referred to as a track channel) of an exhaust gas emission vehicle (901).

The track box of the exhaust gas emission vehicle may be previously stored. In other words, the information of the track box of the exhaust gas emission vehicle may be previously acquired and stored according to the operation of the system 100 for detecting an object during a previous time step.

The track box may be at least one of a plurality of track boxes previously acquired and previously stored according to an operation of the system 100 for detecting an object during a previous time step.

The system 100 for detecting an object may determine an arbitrary exhaust gas virtual area of a track box of an exhaust gas emission vehicle and perform association between the arbitrary exhaust gas virtual area and the track box by applying a conventional association technique.

For example, an arbitrary virtual gas area (VGA) of a track box (Track Box #) of an exhaust gas emission vehicle as shown in FIG. 10 may be determined based on a predetermined width (W) (e.g., 2 m), a predetermined length (L) (e.g., 1 m), and/or a predetermined area.

The system 100 for detecting an object may determine whether a track box-based exhaust gas virtual area of an exhaust gas emission vehicle is successfully associated with the track box (903).

The system 100 for detecting an object may perform operation 905 when the track box-based exhaust gas virtual area of the exhaust gas emission vehicle is successfully associated with the track box (YES in operation 903). The system 100 may perform operation 907 when the track box is not successfully associated with the exhaust gas virtual area (NO in operation 903).

The system 100 for detecting an object may generate and store a track box associated with the exhaust gas virtual area as a new exhaust gas virtual track (905).

The system 100 for detecting an object may output information indicating that the association fails (907).

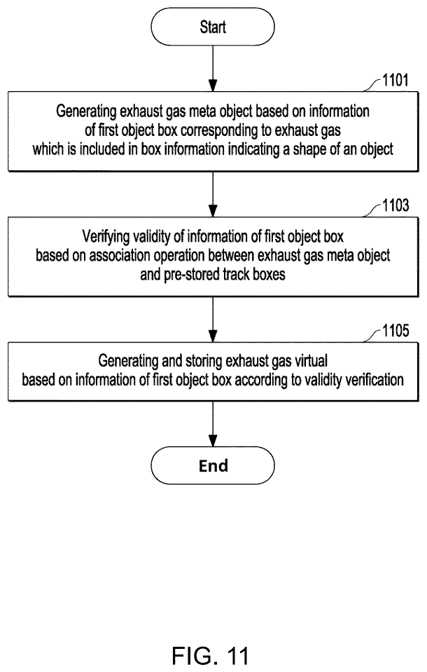

FIG. 11 is a flowchart showing an operation of the system 100 for detecting an object (and/or the processor 130) according to an embodiment of the present disclosure.

Referring to FIG. 11, the system 100 for detecting an object may generate an exhaust gas meta-object based on information of a first object box corresponding to an exhaust gas included in the box information indicating a shape of an object (1101). In other words, the box information includes the information of the first object box.

The system 100 for detecting an object may determine whether the box information indicating a shape of an object includes information of a first object box corresponding to an exhaust gas. The system 100 may perform operation 1101 when the box information indicating the shape of the object includes the information of the first object box.

The exhaust gas meta-object may be generated to have the same data format as the track box for tracking the target object.

The system 100 for detecting an object may perform a validity verification of information of the first object box based on the association operation between the exhaust gas meta object and the previously stored track boxes (1103).

The system 100 for detecting an object may verify the validity of the information of the first object box by identifying whether a predetermined condition is satisfied based on the information of a first track box of the previously stored track boxes when the association between the exhaust gas meta object and the first track box is successful.

For example, the predetermined condition may include at least one of the above-described conditions.

The system 100 for detecting an object may determine that the information of the first object box is valid when the predetermined condition is satisfied. Otherwise, the system 100 may determine that the information of the first object box is not valid.

The system 100 for detecting an object may determine that the information of the first object box is valid when the association between the exhaust gas meta object and the previously stored track boxes fails.

In operation 1105, the system 100 for detecting an object may generate and store the exhaust gas virtual track based on the information of the first object box according to the validity verification.

When the information of the first object box is determined to be valid according to the validity verification, the system 100 for detecting an object may generate and store the exhaust gas virtual track based on the information of the first object box.

For example, the system 100 for detecting an object may generate the virtual meta object based on the information of a first object box. The virtual meta-object may be generated to have the same data format as the track box for tracking the target object.

Also, the system 100 for detecting an object may perform a prediction of the first exhaust gas virtual track at a previous time step with respect to the exhaust gas based on the virtual meta object and perform association between the virtual meta object and the first exhaust gas virtual track.

In addition, when the virtual meta-object and the first exhaust gas virtual track are successfully associated, the system 100 for detecting an object may update the first exhaust gas virtual track to generate the exhaust gas virtual track. The system 100 for detecting an object may generate the virtual meta object as the second exhaust gas virtual track when the association between the virtual meta object and the first exhaust gas virtual track fails.

In addition, the system 100 for detecting an object may release the generation of the virtual meta object as the second exhaust gas virtual track when the number of times that the second exhaust gas virtual track is not associated whenever the time step is changed is equal to or greater than a predetermined threshold number.

The box information indicating the shape of the object in the above-described embodiment may include information of a second object box corresponding to an object other than the exhaust gas and information of a third object box corresponding to an object including both the exhaust gas and the object other than the exhaust gas in addition to the information of the first object box corresponding to the exhaust gas.

Accordingly, the system 100 for detecting an object may determine whether information of a second object box corresponding to an object other than the exhaust gas is included in the box information indicating a shape of the object, and generate the meta object based on the information of the second object box when the information of the second object box is included in the box information indicating the shape of the object.

The meta-object may be generated to have the same data format as a track box for tracking the target object.

Also, the system 100 for detecting an object may generate a meta-object track for tracking-association with respect to the object other than the exhaust gas, based on the meta-object.

In addition, according to the above-described operation, when it is determined that the information of the first object box is valid, the system 100 for detecting an object may store the information of the first object box in the first box information array and store the information of the second object box in the second box information array. In addition, when it is determined that the information of the first object box is invalid, the system 100 for detecting an object may store the information of the third object box in the second box information array.

In addition, the system 100 for detecting an object may determine the second exhaust gas virtual track as the exhaust gas virtual memory track when the virtual meta object is generated as the second exhaust gas virtual track and then the second exhaust gas virtual track is associated before the predetermined threshold number of times. The system 100 for detecting an object may perform an association between the meta object and the exhaust gas virtual memory track.

In addition, when the association between the meta object and the exhaust gas virtual memory track succeeds, the system 100 for detecting an object may update the exhaust gas virtual memory track to the exhaust gas virtual track and remove the meta object.

In addition, when the association between the meta object and the exhaust gas virtual memory track fails, the system 100 for detecting an object may perform the association between the output track box of the system 100 for detecting an object and the exhaust gas virtual memory track.

In addition, the system 100 for detecting an object may update the exhaust gas virtual memory track to the exhaust gas virtual track when the association between the output track box and the virtual memory track succeeds. Otherwise, the system 100 may output information indicating that the association fails.

Further, in addition to the above-described embodiments, the system 100 for detecting an object may determine an arbitrary exhaust gas virtual area in the track box of the object when the object is an exhaust gas emission vehicle.

Further, the system 100 for detecting an object may perform the association between the arbitrary exhaust gas virtual area and the pre-stored track boxes.

In addition, the system 100 for detecting an object may generate at least one track box associated with the arbitrary exhaust gas virtual area as the new exhaust gas virtual track when the association of the arbitrary exhaust gas virtual area with at least one track box among the pre-stored track boxes is successful.

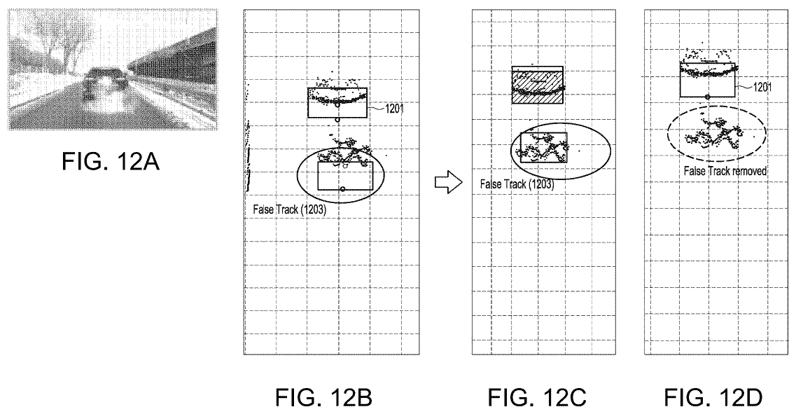

FIGS. 12A-15D are diagrams for explaining an effect of determining an exhaust gas as a false track in a condition in which a preceding vehicle discharges the exhaust gas according to an embodiment of the present disclosure.

Referring to FIG. 12A, when there is a cold weather condition, the concentration of the exhaust gas discharged from the preceding vehicle having the dual exhaust port increases. Accordingly, in the related art, as illustrated in FIG. 12B, points of the exhaust gas are grouped independently and separately from the track box 1201 indicating the preceding vehicle. Thereby, a track box 1203 is generated corresponding to a false track indicating the exhaust gas.

The shape of the track box of the exhaust gas is freely changed, moves in various directions by the wind, and is output to a track of a stationary object. Therefore, the vehicle may unnecessarily perform an operation such as sudden braking according to the control of the vehicle control device of the related art.

However, according to the above-described embodiment of the present disclosure, the track box 1203 (GAS_VIRTUAL) corresponding to the false track indicating the exhaust gas may be managed as an internal track as illustrated in FIG. 12C, and the output may be excluded as illustrated in FIG. 12D.

Referring to FIG. 12D, it can be seen that the false track is removed and only the track box 1201 indicating the preceding vehicle is output, and accordingly, it can be seen that the generation of the false track corresponding to the exhaust gas is blocked.

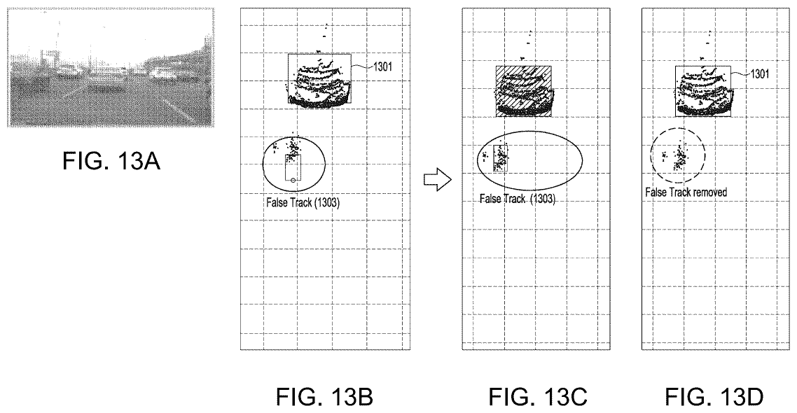

Referring to FIG. 13A, when there is a cold weather condition, the concentration of the exhaust gas discharged from the preceding vehicle having a single exhaust hole increases. Accordingly, in the related art, as illustrated in FIG. 13B, there has been a problem in that the points of the exhaust gas are independently grouped separately from the track box 1301 indicating the preceding vehicle to generate and maintain a track box 1303 corresponding to a false track indicating the exhaust gas.

However, according to the above-described embodiment of the present disclosure, the track box 1303 (GAS_VIRTUAL), corresponding to the false track indicative of the exhaust gas, is generated and maintained as the virtual exhaust gas track as shown in FIG. 13C, such that it may be managed as the internal track and may be excluded from the output as shown in FIG. 13D.

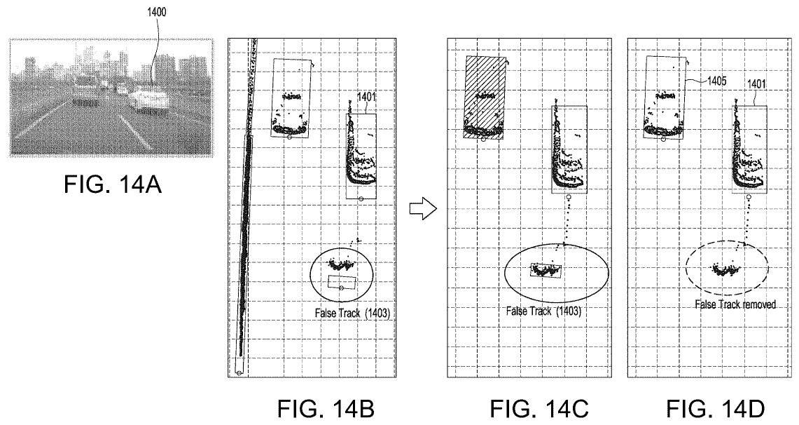

Referring to FIG. 14D, the false track is removed and only the track box 1401 indicating the preceding vehicle is output, and accordingly, it can be seen that the generation of the false track corresponding to the exhaust gas is blocked.

Referring to FIG. 14A, when there is a condition of cold weather, the concentration of the exhaust gas discharged from the target vehicle 1400 located in the lane next to the lane of the vehicle becomes high. Accordingly, in the related art, as shown in of FIG. 14B, the points of the exhaust gas are independently grouped separately from the track box 1401 indicating the target vehicle 1400. Thus, the track box 1403 corresponding to the false track indicating the exhaust gas is generated.

However, according to the above-described embodiment of the present disclosure, the track box 1403 (GAS_VIRTUAL) corresponding to the false track indicating the exhaust gas may be managed as the internal track as illustrated in FIG. 14C, and the output may be excluded as illustrated in FIG. 14D.

Referring to FIG. 14D, it can be seen that the false track is removed and only the track boxes 1401 and 1405 indicating the vehicles preceding the vehicle 1 are output. Accordingly, it can be seen that the generation of the false track corresponding to the exhaust gas is blocked.

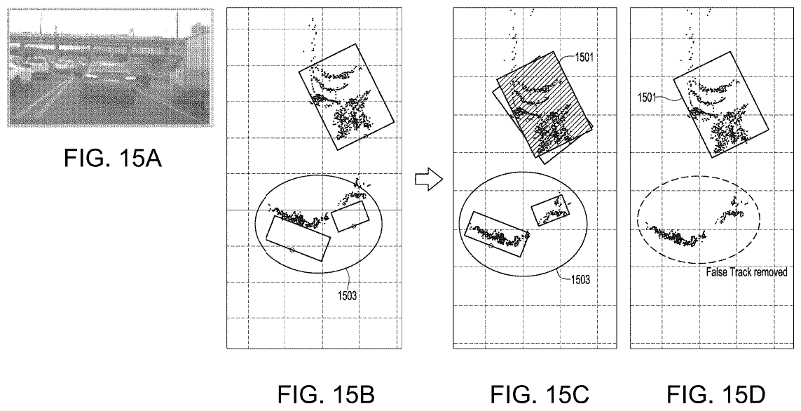

Referring to FIG. 15A, the concentration of the exhaust gas discharged from the preceding vehicle becomes high when there is a condition in which the wind is blowing in cold weather. Accordingly, in the related art, the points of the exhaust gas are grouped alone, and the track box corresponding to the false track indicating the exhaust gas is generated and maintained. In particular, according to the direction and intensity of the wind, the moving speed of the exhaust gas is increased, the shape of the exhaust gas is increased, or the exhaust gas is divided into several pieces, and as shown in FIG. 15B, a plurality of track boxes 1503 corresponding to the false track are generated and maintained.

Accordingly, in the related art, as illustrated in FIG. 15B, there is a problem in that the track boxes 1503 corresponding to the false track indicating the exhaust gas are generated and maintained separately from the track box 1501 indicating the preceding vehicle.

However, according to the above-described embodiment of the present disclosure, the track boxes 1503 (GAS_VIRTUAL) corresponding to the false track indicating the exhaust gas are generated and maintained as the virtual exhaust gas track as shown in FIG. 15C. Therefore, the track boxes may be managed as the internal track and the virtual exhaust gas track may be excluded from being output as shown in FIG. 15D.

Referring to FIG. 15D, it can be seen that the false track is removed and only the track box 1501 indicating the preceding vehicle is output. Accordingly, it can be seen that the generation of the false track corresponding to the exhaust gas is blocked.

The above-described embodiments may be implemented in the form of a recording medium or non-transitory memory for storing instructions executable by a computer including a processor. The instructions may be stored in the form of a program code, and when executed by the processor, may generate a program module to perform operations of the disclosed embodiments. The recording medium may be implemented as a computer-readable recording medium.

The computer-readable recording medium includes all types of recording media in which computer-readable instructions are stored. For example, there may be a Read Only Memory (ROM), a Random Access Memory (RAM), a magnetic tape, a magnetic disk, a flash memory, an optical data storage device, and the like.

The embodiments disclosed above have been described with reference to the accompanying drawings. It should be understood by those of ordinary skill in the art that the present disclosure may be implemented in a different form from the disclosed embodiments without changing the technical idea or essential feature of the present disclosure. The disclosed embodiments are illustrative and should not be construed as limiting.

What is claimed is:

1. A method for detecting an object around a host vehicle, the method comprising:
generating an exhaust gas meta object having a same data format as a track box for tracking the object based on an information of a first object box corresponding to an exhaust gas included in a box information indicating a shape of an object;
verifying a validity of the information of the first object box based on an association between the exhaust gas meta object and pre-stored track boxes; and
generating and storing an exhaust gas virtual track based on the information of the first object box in response to a determination that the information of the first object box is valid.

2. The method of claim 1, wherein verifying the validity of the information of the first object box comprises:
verifying the validity of the information of the first object box based on information of a first track box of the pre-stored track boxes when the exhaust gas meta object is associated with the first track box, and
determining that the information of the first object box is valid when the exhaust gas meta object is not associated with the pre-stored track boxes.

3. The method of claim 2, wherein verifying the validity of the information of the first object box based on the information of the first track box comprises determining that the information of the first object box is valid or invalid based on at least one of an age of the first track box, a distance between the first track box and the host vehicle, whether an object of the first track box has moved, classification information of the object of the first track box, speed information of the object of the first track box, a ratio of an overlapped area of the first track box and the first object box, a distance between the first track box and the first object box, a point ratio between the first track box and the first object box, or any combination thereof.

4. The method of claim 1, wherein generating the exhaust gas virtual track comprises:
generating a virtual meta object having the same data format as the track box based on the information of the first object box;
predicting a first exhaust gas virtual track in a previous time step with respect to the exhaust gas based on the virtual meta object;
performing an association between the virtual meta object and the first exhaust gas virtual track; and
generating the exhaust gas virtual track by updating the first exhaust gas virtual track when the association between the virtual meta object and the first exhaust gas virtual track succeeds.

5. The method of claim 4, wherein generating the exhaust gas virtual track comprises generating the virtual meta object as a second exhaust gas virtual track when the association between the virtual meta object and the first exhaust gas virtual track fails.

6. The method of claim 5, wherein generating the exhaust gas virtual track further comprises, in response to a number of times that association of the second exhaust gas virtual track fails at later time steps is equal to or greater than a predetermined threshold number, releasing the virtual meta object from the second exhaust gas virtual track.

7. The method of claim 6, further comprising:
generating a meta object having the same data format as the track box based on a second object box corresponding to an object other than the exhaust gas included in the box information indicating the shape of the object; and
generating a meta object track for tracking an association with the object other than the exhaust gas based on the meta object.

8. The method of claim 7, wherein generating the exhaust gas virtual track further comprises:
determining the second exhaust gas virtual track as an exhaust gas virtual memory track in response to the association of the second exhaust gas virtual track succeeding before the number of times that association of the second exhaust gas virtual track fails at later time steps reaches the predetermined threshold number of times;
associating the meta object with the exhaust gas virtual memory track; and
updating the exhaust gas virtual memory track as the exhaust gas virtual track and removing the meta object when the associating of the meta object with the exhaust gas virtual memory track succeeds.

9. The method of claim 8, wherein generating the exhaust gas virtual track comprises:
performing an association between an output track box of a system for detecting an object and the exhaust gas virtual memory track when the association between the meta object and the exhaust gas virtual memory track fails; and
updating the exhaust gas virtual memory track as the exhaust gas virtual track when the association between the output track box and the exhaust gas virtual memory track succeeds.

10. The method of claim 7, further comprising:
when it is determined that the information of the first object box is valid, storing the information of the first object box in a first box information array and storing the information of the second object box in a second box information array; and
when it is determined that the information of the first object box is not valid, storing information of a third object box included in the box information and corresponding to an object comprising all of the exhaust gas and the object other than the exhaust gas in the second box information array.

11. The method of claim 1, further comprising:
when the object is an exhaust gas emission vehicle, determining an arbitrary exhaust gas virtual area in a track box of the object;
performing an association between the arbitrary exhaust gas virtual area and the pre-stored track boxes; and
when the arbitrary exhaust gas virtual area and at least one track box of the pre-stored track boxes are associated with each other, generating the at least one track box associated with the arbitrary exhaust gas virtual area as a new exhaust gas virtual track.

12. A system for detecting an object around a host vehicle, the system comprising:
a memory; and
a processor connected to the memory, wherein the processor is configured to
generate an exhaust gas meta object having a same data format as a track box for tracking the object based on an information of a first object box corresponding to an exhaust gas included in box information indicating a shape of an object,
verify a validity of the information of the first object box based on an association operation between the exhaust gas meta object and pre-stored track boxes, and
generate and store an exhaust gas virtual track based on the box information of the first object box in response to a determination that the information of the first object box is valid according to the verification.

13. The system of claim 12, wherein the processor is further configured to:
verify the validity of the information of the first object box based on information of a first track box of the pre-stored track boxes when the exhaust gas meta object is associated with the first track box; and
determine that the information of the first object box is valid when the exhaust gas meta object is not associated with the pre-stored track boxes.

14. The system of claim 13, wherein the processor is further configured to determine that the information of the first object box is valid or invalid based on at least one of an age of the first track box, a distance between the first track box and the host vehicle, whether an object of the first track box has moved, classification information of an object of the first track box, speed information of the object of the first track box, a ratio of an overlapped area of the first track box and the first object box, a distance between the first track box and the first object box, a point ratio between the first track box and the first object box, or any combination thereof.

15. The system of claim 12, wherein the processor is further configured to:
generate a virtual meta object having the same data format as the track box based on the information of the first object box;
predict a first exhaust gas virtual track in a previous time step with respect to the exhaust gas based on the virtual meta object;
perform association between the virtual meta object and the first exhaust gas virtual track; and
generate the exhaust gas virtual track by updating the first exhaust gas virtual track when the association between the virtual meta object and the first exhaust gas virtual track succeeds.

16. The system of claim 15, wherein the processor is further configured to generate the virtual meta object as a second exhaust gas virtual track when the association between the virtual meta object and the first exhaust gas virtual track fails.

17. The system of claim 16, wherein the processor is further configured to, in response to a number of times in which association of the second exhaust gas virtual track fails at later time steps is equal to or greater than a predetermined threshold number, release the virtual meta object from the second exhaust gas virtual track.

18. The system of claim 17, wherein the processor is further configured to:
generate a meta object having the same data format as the track box based on a second object box corresponding to an object other than the exhaust gas included in the box information indicating the shape of the object; and
generate a meta object track for tracking an association with the object other than the exhaust gas based on the meta object.

19. The system of claim 18, wherein the processor is further configured to:
determine the second exhaust gas virtual track as an exhaust gas virtual memory track when the association of the second exhaust gas virtual track succeeds before the number of times in which association of the second exhaust gas virtual track fails at later time steps reaches the predetermined threshold number of times;
associate the meta object with the exhaust gas virtual memory track; and
update the exhaust gas virtual memory track as the exhaust gas virtual track and remove the meta object when the association of the meta object with the exhaust gas virtual memory track succeeds.

20. The system of claim 19, wherein the processor is configured to:
perform an association between an output track box of a system for detecting an object and the exhaust gas virtual memory track when the association between the meta object and the exhaust gas virtual memory track fails; and
update the exhaust gas virtual memory track as the exhaust gas virtual track when the association between the output track box and the virtual memory track succeeds.
